(19) United States
(12) Patent Application Publication
(10) Pub. No.: US 2004/0003052 A1
(43) Pub. Date: Jan. 1, 2004

(54) Data detection method, apparatus, and program

(75) Inventor: Akira Yoda, Kaisei-machi (JP)

Correspondence Address: SUGHRUE MION, PLLC, 2100 PENNSYLVANIA AVENUE, N.W., WASHINGTON, DC, 20037, US

(73) Assignee: Fuji Photo Film Co., Ltd.

(21) Appl. No.: 10/391,611

(22) Filed: Mar. 20, 2003

(30) Foreign Application Priority Data
Mar. 20, 2002 (JP) 079349/2002

(51) Int. Cl. G06F 15/16

(52) U.S. Cl. 709/217

(57) ABSTRACT

Embedded data is accurately detected from an image of a printed matter recording an image in which data has been embedded, which has been obtained by an imaging means, even if the imaging means is not of high-performance. An imaging portion of a camera equipped cellular phone images a printed matter, on which an image data in which the URL of the storage location of audio data has been embedded as a digital watermark is recorded, to obtain an image data. A distortion correcting portion corrects the image distortions caused by the imaging portion to obtain a corrected image data, and detects the URL from the corrected image data. The data representing the detected URL is sent to an image server, which retrieves, based on the URL, the audio data, and sends it to the camera equipped cellular phone. The camera equipped cellular phone reproduces the audio data.

### BACKGROUND OF THE INVENTION

1. Field of the Invention

The present invention relates to a data detection method and apparatus for detecting data embedded in an image, and a program causing a computer to implement the data detection method.

2. Description of the Related Art

There are in wide use today systems wherein data indicating the storage location, such as a URL, of electronic data, is attached to an image as a bar code or a digital watermark, which is then printed out to obtain printed matter recording the image such as a print. Then, the obtained printed matter is read out by use of a read out apparatus such as a scanner or the like; wherein, the data that had been attached to the image can be detected by analyzing the read out image data, and the storage location of the electronic data accessed to obtain the electronic data (e.g., U.S. Pat. No. 5,841,978, Digimarc MediaBridge Home Page, Connect to what you want from the web (found on Mar. 5^{th}, 2002) at URL: http://www.digimarc.com/mediabridge/).

Meanwhile, the prevalence of cellular phones has been significant. In recent years, portable terminal apparatuses equipped with digital still cameras (hereinafter, referred to as “cameras”) for obtaining digital data, such as cellular phones equipped with cameras, have become increasingly popular (e.g., Japanese Unexamined Patent Publication Nos. 6 (1994)-233020 and 2000-253290). Further, camera equipped portable terminals such as PDA portable terminals and the like equipped with an internal camera have also been proposed (Japanese Unexamined Patent Publication Nos. 8(1996)-140072 and 9(1997)-65268.

By using such camera equipped portable terminal apparatuses, a user can set desired image data obtained thereby as the background image to be shown on the monitor screen of the portable terminal apparatus. Further, obtained image data can be attached to an email and sent to a friend. Therefore, it has become possible to show one's friends and the like the current situation one is in, that is, such as by sending a picture of oneself wearing a sorrowful expression, whereby, it has become possible to conveniently communicate with friends when circumstances force one to cancel an appointment or to be late for an appointment, and the like.

Further, by detecting in the same manner as described above the data indicating the storage location of the electronic data from an image obtained by use of a camera equipped portable terminal apparatus of a printed matter such as that described above in which data has been embedded, the storage location can be accessed and the electronic data obtained by a camera equipped portable terminal apparatus.

However, because the imaging lens with which the camera of a camera equipped portable terminal apparatus is equipped does not exhibit a very high performance level, the images obtained thereby have an extraordinarily high degree of distortion. Therefore, for cases in which a printed matter that has data of a bar code or digital watermark embedded therein is read out, because the data embedded in the image represented by the image data is also distorted, a problem arises in that the data cannot be correctly detected. Tests have been performed in an attempt to solve the above-described problems. A camera equipped with an image obtaining device provided with an imaging element having more than 6,000,000 pixels was used to read out an image of high image quality. However, many readout errors were generated, and the data attached to the image could not be read out.

### SUMMARY OF THE INVENTION

The present invention has been developed in view of the foregoing circumstances, and it is an objective of the present invention to enable data to be accurately detected by use, in particular, of a camera equipped portable terminal apparatus even if the imaging element of the camera does not exhibit a particularly high level of performance.

The data detection method according to the present invention comprises the steps of:

receiving input of image data representing an image of printed matter having recorded thereon an image to which data has been attached, which has been obtained by imaging, by use of an imaging means,

correcting the geometrical distortions of the image data to obtain a corrected image data, and

detecting the aforementioned data from the corrected image data.

Here, “data” refers to the data attached to an image as a bar code. However, it is preferable that the data be attached to the image in the form of a digital water mark that has been concealedly embedded therein.

Further, “to which data has been attached” refers not only to the recording of data to be included in the actual body of the image, but also to the recording of data in the vicinity of the image in the printed matter.

The geometrical distortions of the image data are mainly caused by the imaging lens with which the imaging means has been provided; however, they are not limited to this.

The correction of the geometrical distortions of the image data can be carried out by recording the distortion properties data representing the properties of the distortion caused by the imaging lens with which the imaging means has been provided, and performing the corrections based on the recorded properties data. Further, a method of computing the distortion properties of the lens of the camera from only the image data obtained thereby has been proposed (see “Blind removal of lens distortion,” Harry Farid and Alin C. Popescu, Optical Society of America, A/Vol. 18, No. 9/September 2001, pp. 2072-77).

Note that according to the data detection method of the present invention, the imaging means can be a camera with which a portable terminal apparatus has been provided.

Further, according to the data detection method of the present invention, the data can be storage location data representing the storage location of audio data that has been associated with the images, and

the audio data can be obtained based on the storage location data.

The data detection apparatus according to the present invention comprises:

an image data inputting means for receiving input of image data representing an image of printed matter having recorded thereon an image to which data has been attached, which has been obtained by imaging, by use of an imaging means,

a correcting means for correcting the geometrical distortions of the image data to obtain corrected image data, and

a data detecting means for detecting the embedded data from said corrected image data.

Note that according to the data detection apparatus of the present invention, the data can be attached to the image data by being concealedly embedded in said image data.

Further, according to the data detection apparatus of the present invention, the imaging means can be a camera with which a portable terminal apparatus has been provided.

Still further, with regard to the data detection apparatus of the present invention, the data can be storage location data representing the storage location of a audio data that has been associated with the image, and

the data detection apparatus may further comprise an audio data obtainment means for obtaining the audio data based on said storage location data.

Note that the data detection method according to the present invention can be provided as a program for causing a computer to implement said data detection method.

According to the present invention, an image of a printed matter having recorded thereon an image to which data has been attached is imaged by an imaging means to obtain image data representing the image recorded on the printed matter. Then, the geometrical distortions of the image data are corrected to obtain corrected image data, and the aforementioned attached data is detected from the corrected image data. Therefore, even if the imaging means is not of a particularly high performance level and geometrical distortions are present in the obtained image data, in the corrected image represented by the corrected image data, the data embedded in the image recorded on the printed matter become embedded in an undistorted state. Accordingly, by basing the detection of the embedded data on the corrected image data, the embedded data can be detected with a high degree of accuracy.

In particular, for cases in which data such as a digital watermark is attached to an image data by being concealedly embedded therein, it is extremely easy for the data to become damaged. According to the present invention, because the embedded data is free of distortion, it is possible to detect the concealedly embedded data without damaging it.

Further, for cases in which the geometrical distortions in an image data are large, such as when an image data is obtained by the camera of a camera equipped portable terminal apparatus, the effectiveness of the correction process according to the present invention is extraordinarily large.

Still further, if the data is a storage location data representing the storage location, such as a URL or the like, of audio data that has been associated with the image, by accessing the storage location of the audio data, based on the storage location data, and obtaining the audio data, the user who has obtained the audio data can reproduce and enjoy listening to the audio data associated with the image.

### BRIEF DESCRIPTION OF THE DRAWINGS

FIG. 1 is a block diagram of a data transmitting system employing the first embodiment of the data detection apparatus according to the present invention,

FIG. 2 is an explanatory drawing illustrating an embedding algorithm of a digital watermark,

FIG. 3 is a flowchart of the operation of the first embodiment,

FIG. 4 is a block diagram of a data transmitting system employing the second embodiment of the data detection apparatus according to the present invention,

FIG. 5 is a flowchart of the operation of the second embodiment,

FIG. 6 is a block diagram of a data transmitting system employing the third embodiment of the data detection apparatus according to the present invention.

FIG. 7 is a block diagram of a data transmitting system employing the fourth embodiment of the data detection apparatus according to the present invention, and

FIG. 8 is a flowchart of the operation of the fourth embodiment.

### DESCRIPTION OF THE PREFERRED EMBODIMENTS

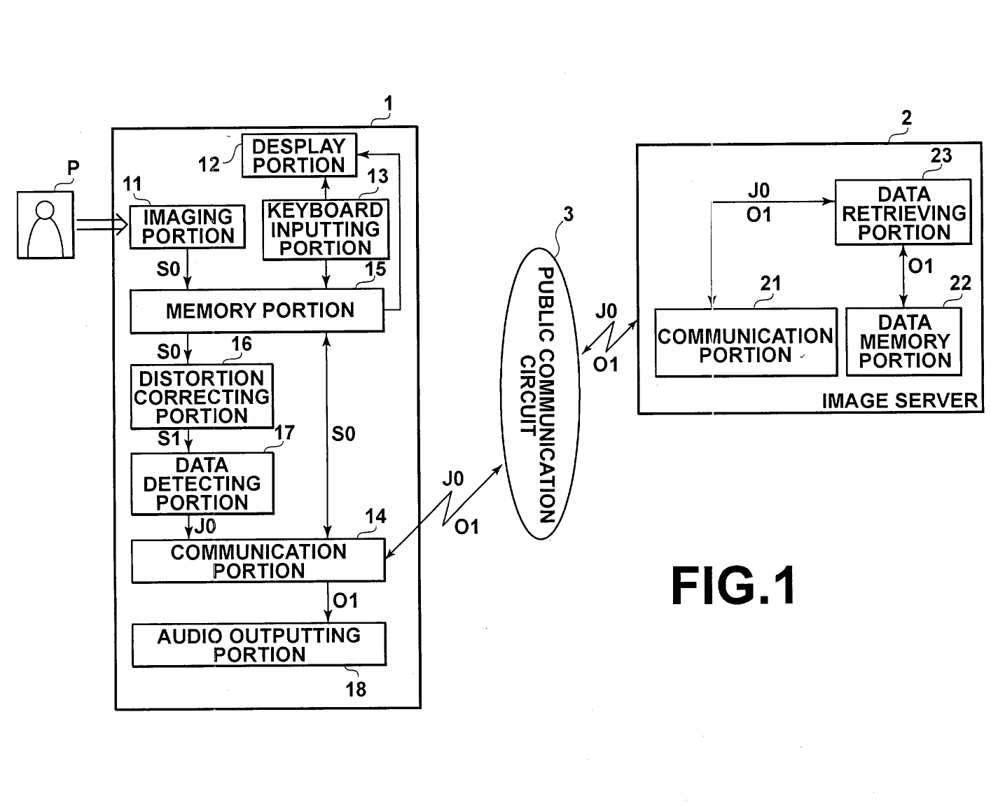

Hereinafter the preferred embodiments of the present invention will be explained with reference to the attached drawings. FIG. 1 is a block diagram of a data transmitting system employing the first embodiment of the data detection apparatus according to the present invention. As shown in FIG. 1, the data transmitting system according to the first embodiment of the present invention is a system for exchanging data between a camera equipped portable terminal apparatus 1 and various data storing image servers 2 over a public communication network 3 therebetween.

The camera equipped portable terminal apparatus 1 comprises: an imaging portion 11 for obtaining image data S0 representing an image recorded on printed matter P that has been obtained by imaging the printed matter P, on which an image in which data has been embedded is recorded; a display portion 12 for displaying images and various types of data; a keyboard input portion 13 formed from a plurality of input keys such as a cruciform key and the like; a communication portion 14 for transmitting and receiving data, telephone calls, and email over a public communication network 3; a memory portion 15 for recording on amemory card or the like the image data S0 obtained by the imaging portion 11; a correcting portion 16 for correcting the geometrical distortions of the image data S0 to obtain corrected image data S1; a data obtaining portion 17 for obtaining the data embedded in the printed matter P from the corrected image data S1; and an audio output portion 18 such as a speaker or the like for outputting audio.

The imaging portion 11 is formed of an imaging lens, a shutter, an imaging device and the like. Note that a wide angle lens having an f≦28 mm when calculated as a 35 mm camera is used as the imaging lens. Further, a color CMOS sensor, a color CCD sensor or the like is used as the imaging device.

The display portion 12 is formed of a liquid crystal display monitor or the like. Note that according to the current embodiment, the image data S0 can be reduced and the entirety thereof displayed on the display portion 12; however, the image data S0 can be displayed on the display portion 12 as it is without being reduced. In this case, by scrolling through the displayed image by use of the cruciform key of the keyboard input portion 13, the content of the entirety of the image can be apprehended.

Here, the printed matter P, of which an image is to be obtained by the imaging portion 11, has embedded therein as a digital watermark the URL of an image server 2 at which audio data O1 corresponding to the image printed on the printed matter P is stored. The digital watermark is embedded, by use of an algorithm such as that shown below, for example, in image data S10 representing the image recorded on the printed matter P.

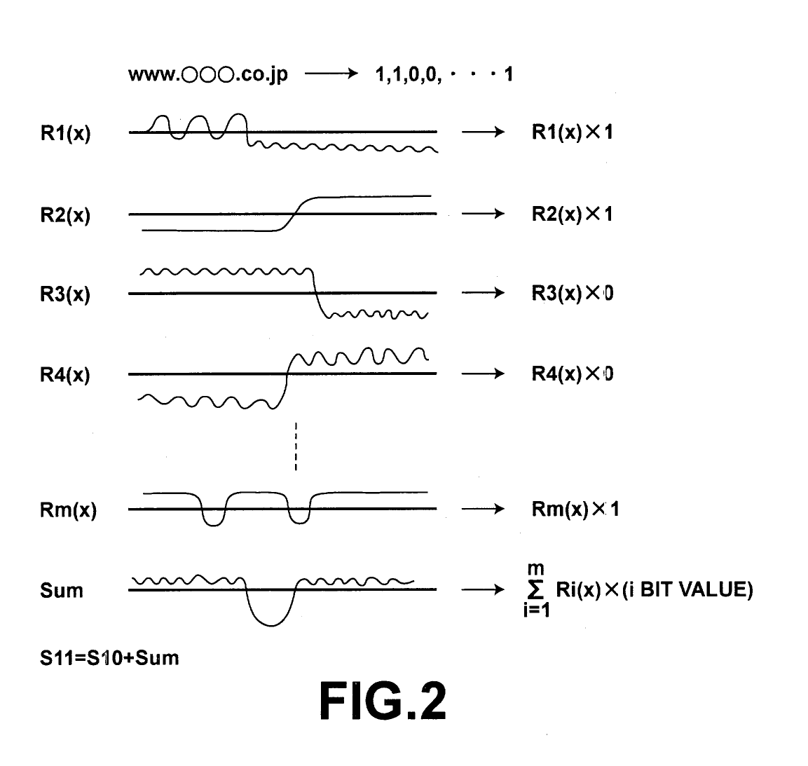

FIG. 2 is a drawing illustrating an embedding algorithm for a digital watermark. First, n types (e.g., if the embedded data is 128-bit data, 128 types) of pseudo-random patterns Ri (i=1˜n) are formed. Note that the random pattern in actuality is a two dimensional pattern Ri(x, y). However, for the sake of explanation, it will be represented as a one dimensional pattern Ri(x). Then, the value of the number i bit, for a case in which the URL of the image server 2 storing the audio data O1 is represented by 128-bit data, is multiplied by the corresponding i number random pattern Ri(x). That is to say, if the URL of the image server 2 is, for example, represented starting from the first bit as 1, 1, 0, 0 . . . 1 in that order, R1(x)×1, R2(x)×1, R3(x)×0, R1(x)×0, R4(x)×0, . . . , . . . Rn(x)×1 is calculated. Further, the total, Sum {=ΣRi(x)×(value of the number i bit)} of R1(x)×1, R2(x)×1, R3(x)×0, R1(x)×0, R4(x)×0, . . . Ri(x)×(value of the number i bit), . . . Rn(x)×1 is calculated. Then, by adding the calculated Sum to the image data S10, image data S11 in which the data has been embedded is obtained. By printing out the image data S11, printed matter P recording an image in which the data has been embedded is obtained.

Next, the printed matter P is imaged to obtain image data S0 representing the image recorded by the printed matter P. Then, the relative values of all of the pseudo-random patterns Ri(x) relative to the image data S0 are obtained, and the comparatively large pseudo-random patterns Rj(x) of the relative values are assigned a value of 1, and the other pseudo-random patterns Rj(x) are assigned a value of 0. By arranging the assigned values 1, 0 in order from the number 1 pseudo-random pattern Rj(x), the 128-bit data, that is, the URL of the image server 2 storing the audio data O1 can be detected.

Here, the image data S0 obtained by the imaging of the printed matter P by the imaging portion 11 should be an image corresponding to the image data S11. However, because a wide angle lens is used as the imaging lens of the imaging portion 11, the image represented by the image data S1 contains geometrical distortions caused by the imaging lens of the imaging portion 11. Accordingly, even if the relative values of the image data S0 and the pseudo-random patterns Rj(x, y) are calculated, because the pseudo-random patterns Rj(x, y) are distorted, the relative values are not large and the data embedded in the image recorded by the printed matter P cannot be detected.

Therefore, according to the current embodiment, the geometrical distortions contained in the image data S0 are corrected by the distortion correcting portion 16 to obtain a corrected image data S1.

The data detecting portion 17 obtains the relative values of the image data S0 and the pseudo-random patterns Rj(x, y) as described above, and obtains a data J0 representing the URL of the image server 2 storing the audio data embedded in the image recorded on the printed matter P.

The image server 2 comprises: a communication portion 21 for sending and receiving data over a public communications network 3; a data memory portion 22 for remembering various types of data such as audio data and the like; and a data retrieving portion 23 for searching, based on the data J0 sent from the camera equipped cellular phone 1, the data memory portion 22 to obtain the audio data O1 specified by the URL represented by the data J0.

Note that the audio data C1 is audio data that has been recorded by the user who has obtained the image data S10 representing the image printed on the printed matter P (hereinafter referred to as the generating user). The audio data O1 is recorded when the image data S0 is obtained by the digital camera and recorded on the memory card together with the image data S10. Then, by bringing the memory card to a DPE store, the generating user can have the audio data O1 uploaded to the image server 2 from the DPE store. Note that it is also possible that the generating user upload the audio data O1 to the image server 2 utilizing his or her own personal computer over the Internet. When printing out the image data S10 received from the generating user, the DPE store embeds in the image data S10 the URL representing the storage location of the audio data O1 as a digital watermark to obtain an image data S11, and prints out the image data S11 to obtain the printed matter P.

Note that there are cases in which moving images obtained by a digital video camera are printed out one frame at a time. In this case, the audio data O1 can be data representing audio recorded along with the moving images.

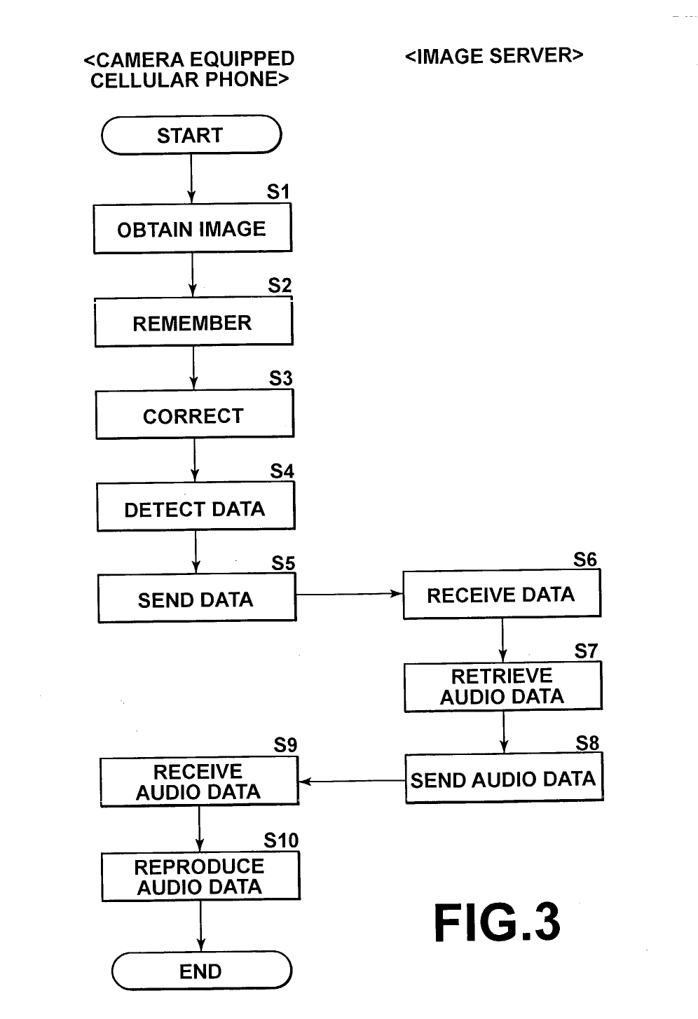

Next, the operation of the first embodiment will be explained. FIG. 3 is a flowchart of the operation of the first embodiment. Note that the user of the camera equipped cellular phone 1 (hereinafter referred to as the receiving user) has been given printed matter P. First, at the command of the receiving user, the imaging portion 11 images the printed matter P to obtain an image data S0 (step S1). The memory portion 15 temporarily stores the image data S0 (step S2). Then, the distortion correcting portion 16 reads out the image data S0 from the memory portion 15 and corrects the geometrical distortions contained in the image data S0 to obtain a corrected image data S1 (step S3). Continuing, the data detecting portion 17 detects the data J0 representing the URL of the audio data O1 that has been embedded in the corrected image data S1 (step S4). When the data J0 is detected, the communication portion 14 sends the data J0 to the image server 2 over the public communication circuit 3 (step S5).

The communication portion 21 of the image server 2 receives the data J0 (step S6). Next, the data retrieving portion 23 of the image server 2 retrieves, based on the URL represented by the data J0, the audio data O1 from the memory portion 22 (step S7). Then, the communication portion 21 sends the detected audio data O1 to the camera equipped cellular phone 1 over the public communication circuit 3 (step S8).

The communication portion 14 of the camera equipped cellular phone 1 receives the audio data 01 (step S9), and the audio output portion 18 plays back the audio data 01 (step S10), whereby the processing is complete.

The receiving user can view the image displayed on the display portion 12 of the camera equipped cellular phone 1 and also listen to the audio recording corresponding to said image.

In this manner, according to the first embodiment, the geometrical distortions of the image data S0 obtained by the imaging portion 11 are corrected to obtain corrected image data S1, and the data J0 representing the URL of the audio data O1 is obtained from the corrected image data S1. Therefore, even if the imaging portion 11 does not exhibit a very high performance level and the image data S0 includes geometrical distortions caused by the imaging lens of the imaging portion 11, the data J0 embedded in the image recorded on the printed matter P becomes embedded in a non-distorted state in the corrected image represented by the corrected image data Si. Accordingly, the embedded data J0 can be detected with a high degree of accuracy.

Note that, according to the first embodiment, instead of a digital watermark, the URL of the audio data 01 can be attached to the image data S0 as a barcode. Further, the barcode can be recorded on the printed matter in the vicinity of the image represented by the image data S0. In this case, data that associates the barcode and the URL of the storage location of the audio data 01 stored in the image server 2, and barcode data representing the bar code is sent from the camera equipped cellular phone 1 to the image server 2. The image server 2 obtains, based on the bar code data, the URL of the storage location of the audio data 01, and obtains the audio data O1 based on the obtained URL.

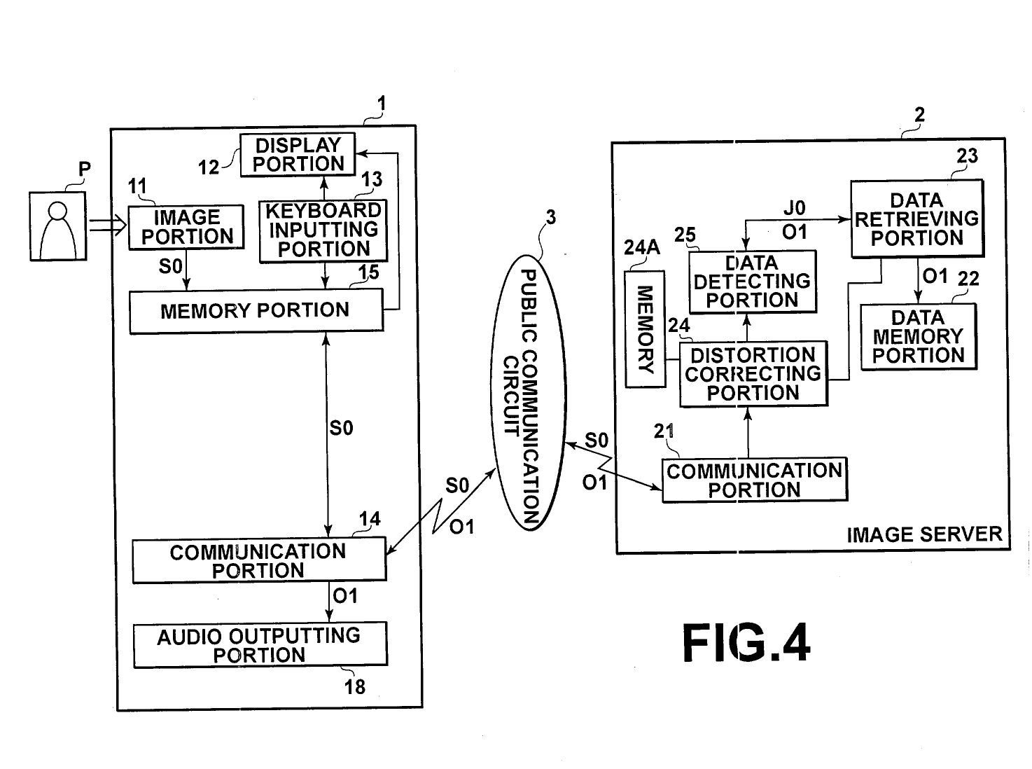

Next, the second embodiment of the present invention will be explained. FIG. 4 is a block diagram of a data transmitting system employing the second embodiment of the data detection apparatus according to the present invention. Note that elements of the second embodiment common to the first embodiment are likewise labeled, and further explanation thereof is omitted. According to the second embodiment, a point of difference with the first embodiment resides in that the image data S0 obtained by the camera equipped cellular phone 1 is sent to the image server 2, and the image server 2 performs the detection of the data J0. Therefore, according to the second embodiment, the image server 2 is provided with a distortion correcting portion 24 and a data detecting portion 25.

Note that according to the second embodiment, the distortion correcting portion 24 is provided with a memory 24a for recording the distortion properties corresponding to the model type of the camera equipped cellular phone 1. In the memory 24a, the model type data of the camera equipped cellular phone 1 is associated with the distortion properties data. Then, based on the model type data sent from the camera equipped cellular phone 1, the corresponding model type distortion properties data is read out and the correction of the distortion of the image data S0 performed. Note that camera equipped cellular phones 1 are assigned unique phone numbers corresponding to the model types thereof. Therefore, data associating the phone numbers and model type data is recorded in the memory 24A, whereby the distortion properties data can be read out by sending the telephone number from the camera equipped cellular phone 1.

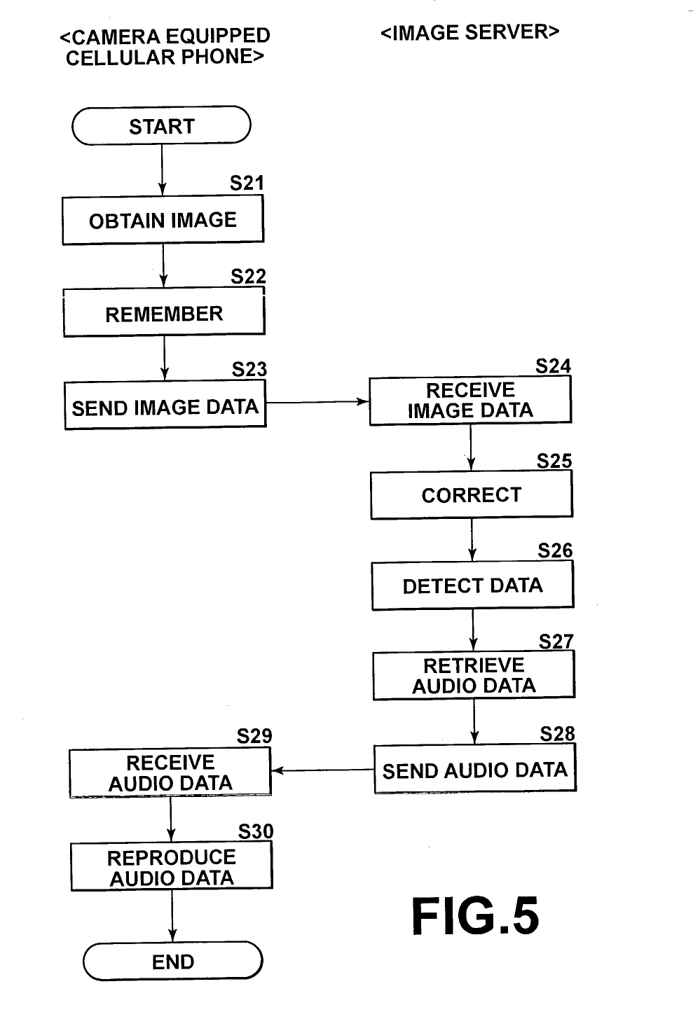

Next, the operation of the second embodiment will be explained. FIG. 5 is a flowchart of the operation of the second embodiment. Note that the receiving user has been given printed matter P. First, at the command of the receiving user, the imaging portion 11 images the printed matter P to obtain image data S0 (step S21). The memory portion 15 temporarily stores the image data S0 (step S22). Then, the communication portion 14 reads out the image data S0 from the memory portion 15 and sends the data J0 to the image server 2 over the public communication network 3 (step S23).

The communication portion 21 of the image server 2 receives the data J0 (step S24), and the distortion correcting portion 24 corrects the geometrical distortions contained in the image data S0 to obtain a corrected image data S1 (step 25). Continuing, the data detecting portion 25 detects the data J0 representing the URL of the audio data O1 that has been embedded in the corrected image data S1 (step S26). When the data J0 is detected, the data retrieving portion 23 of the image server 2 retrieves, based on the URL represented by the data J0, the audio data O1 from the data memory portion 22 (step S27). Then, the communication portion 21 sends the retrieved audio data O1 to the camera equipped cellular phone 1 over the public communication circuit 3 (step S28).

The communication portion 14 of the camera equipped cellular phone 1 receives the audio data O1 (step S29), and the audio output portion 18 plays back the audio data O1 (step S30), whereby the processing is complete.

The receiving user can view the image displayed on the display portion 12 of the camera equipped cellular phone 1 and also listen to the audio recording corresponding to said image.

In this manner, according to the second embodiment, even if the imaging portion 11 does not exhibit a very high performance level and the image data S0 includes geometrical distortions caused by the imaging lens of the imaging portion 11, the data J0 embedded in the image recorded by the printed matter P becomes embedded in a non-distorted state in the corrected image represented by the corrected image data S1. Accordingly, the embedded data J0 can be detected with a high degree of accuracy, and the audio data O1 can be retrieved, based on the data J0, and sent to the camera equipped cellular phone 1.

Further, according to the second embodiment, because the data J0 is detected in the image server 2, it is not necessary for the camera equipped cellular phone 1 to perform the process of detecting the data J0; as a result, the processing load of the camera equipped cellular phone 1 can be reduced compared to the first embodiment. Further, because it becomes unnecessary to provide the camera equipped cellular phone 1 with a distortion correcting portion and a data detecting portion, the cost of the camera equipped cellular phone 1 can be reduced compared to the first embodiment, and the power consumption of the camera equipped cellular phone 1 can also be reduced.

Still further, although the embedding algorithm is renewed frequently, by providing the data detecting portion 25 in the image server 2, the frequent changing of the algorithm can be accommodated.

Note that, with regard to the second embodiment, instead of a digital watermark, the URL of the audio data O1 can be attached to the image data S0 as a barcode. Further, the barcode can be recorded on the printed matter in the vicinity of the image represented by the image data SO. In this case, data that associates the barcode and the URL of the storage location of the audio data O1 is stored in the image server 2, and the image server 2 detects the barcode data representing a bar code from the image data S0 sent thereto from the camera equipped cellular phone 1. Then, the image server 2 obtains, based on the bar code data, the URL of the storage location of the audio data O1, obtains the audio data O1 based on the obtained URL, and sends the audio data O1 to the camera equipped cellular phone 1.

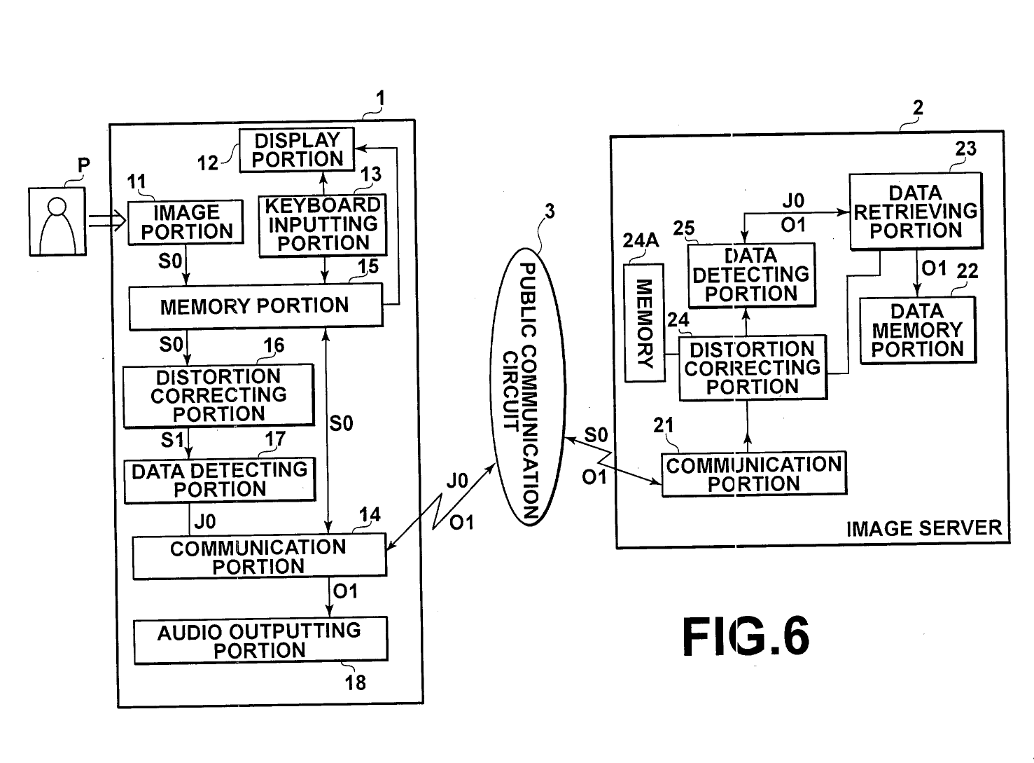

Next, the third embodiment of the present invention will be explained. FIG. 6 is a block diagram of a data transmitting system employing the third embodiment of the data detection apparatus according to the present invention. Note that elements of the third embodiment common to the first and second embodiments are likewise labeled, and further explanation thereof is omitted. According to the third embodiment, a point of difference with the first and second embodiments resides in that both the camera equipped cellular phone 1 and the image server 2 are capable of detecting the data J0.

In this fashion, by making it possible to detect the data J0 at both the camera equipped cellular phone 1 and the image server 2, only the data J0 is sent to the image server 2 when it is possible to detect the data J0 at the camera equipped cellular phone 1, and the image data S0 can be sent to the image server 2 only when it is not possible to detect the data J0 at the camera equipped cellular phone 1. Therefore, it becomes possible to save on communications costs, because the image data S0 can be sent from the camera equipped cellular phone 1 to the image server 2 only when necessary.

Further, for cases in which a first data (J1) is embedded in the image data S10 using a comparatively simple algorithm (a first algorithm), which is easily detected but only capable of embedding data that is of small quantity, and a second data (J2) is embedded in the image data S10 using an algorithm (a second algorithm), which is capable of embedding data that is of a comparatively large quantity but that is difficult to detect, the third embodiment exhibits exceptional effectiveness with respect to the point of improving the discreteness with which the storage location of the audio data O1 can be embedded.

That is to say, the data detecting portion 17 of the camera equipped cellular phone 1 is made capable of detecting only the data J1 by use of the comparatively simple first algorithm and the data detecting portion 25 of the image server 2 is made capable of detecting the data J2 by use of the second algorithm, and the URL of the image server 2 is embedded by use of the first algorithm and the URL of the server actually storing the audio data O1 (a server other than the image server 2) is embedded by use of the second algorithm.

Then, the image data S0 is sent to the image server 2 of the URL detected at the data detecting portion 17 of the camera equipped cellular phone 1, and the data detecting portion 25 of the image server 2 detects the URL storing the audio data O1. Next, the image server 2 obtains the audio data O1 from another server, and sends the obtained audio data O1 to the camera equipped cellular phone 1, whereby it becomes possible to reproduce the audio data at the camera equipped cellular phone 1.

Because the Internet is accessed, emails are sent and received using cellular phones, a relay server is provided by the cellular phone company so as to facilitate access to Web servers and mail servers; whereby the cellular phones can access Web servers and send and receive emails via the relay server. Therefore, the audio data 01 can be stored at a Web server, and a relay server can be equipped with data detection apparatus according to the present invention. Hereinafter, this configuration will be described as a fourth embodiment.

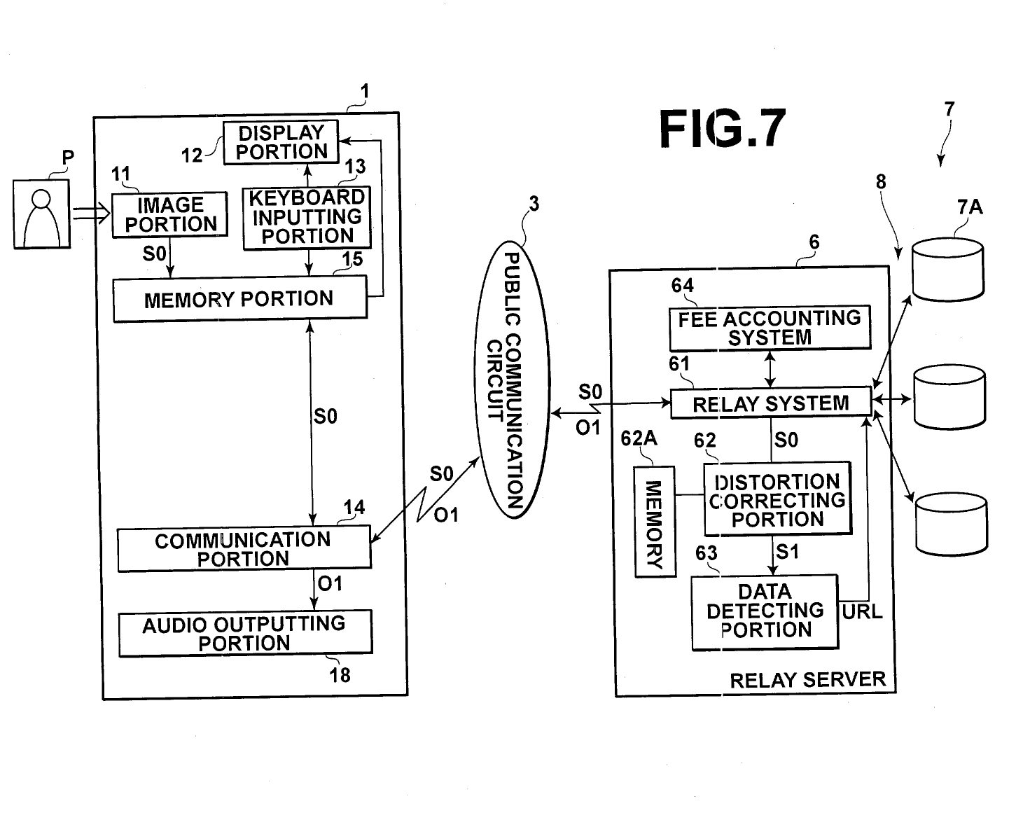

FIG. 7 is a block diagram of a cellular phone relay system employing the fourth embodiment of the data detection apparatus according to the present invention. Note that elements of the fourth embodiment common to the first embodiment are likewise labeled, and further explanation thereof is omitted.

As shown in FIG. 7, the cellular phone relay system transfers data among a camera equipped cellular phone 1, a relay server 6, and a server cluster 7 made up of web servers, e-mail servers and the like, via a network 8.

Note that according to the fourth embodiment, the camera equipped cellular phone 1 to be utilized comprises, the same as the camera equipped cellular phone 1 utilized in the data transmitting system of the second embodiment, an imaging portion 11, a display portion 12, a keyboard 13, a communication portion 14, a memory portion 15 and a audio output portion 18.

The relay server 6 comprises: a relay system 61 for performing relay between the cellular phone 1 and the server cluster 7; a distortion correcting portion 62, corresponding to the distortion correcting portions 16, 24 of the first and second embodiments; a data detecting portion 63 corresponding to the data detecting portions 17, 25 of the first and second embodiments; and a fee accounting system 64 for managing the communication charges for the camera equipped cellular phone 1. Note that the distortion correcting portion 62 is provided with a memory 62a corresponding to the memory 24a of the second embodiment, which records distortion properties data corresponding to the model types of the camera equipped cellular phones 1.

Note that according to the fourth embodiment, the data detecting portion 63 is provided with a function for detecting the URL of the storage location of the audio data O1 from the corrected image data S1, and a function for inputting the detected URL to the relay system 61.

The relay system 61, upon receiving input of the URL from the data detecting portion 63, accesses the Web server (here, 7a) corresponding to the URL, reads out the audio data O1 stored thereat, and sends the read out audio data O1 to the camera equipped cellular phone 1. Note that for cases in which the URL of the storage location of the audio data 01 has not been embedded in the print P imaged by the camera equipped cellular phone 1, data indicating that this is the case is input from the data detecting portion 63 to the relay system 61. The relay system 61 sends an email describing the fact that the aforementioned URL has not been embedded in the aforementioned print P to the camera equipped cellular phone 1 so as to inform the user of the camera equipped cellular phone 1 that data linking the audio data O1 to the image data S0 sent from the camera equipped cellular phone 1 had not been appended to said image data S0.

The fee accounting system 64 manages the communications charges to the camera equipped cellular phone 1. According to the present embodiment, a URL is embedded in the print P, and the fee accounting system starts charging the camera equipped cellular phone 1 at the stage in which the Web server 7a is accessed by the relay system 61 to obtain the audio data O1. For cases in which the URL has not been embedded in the print P, because the relay system 61 has not accessed any of the servers in the server cluster 7, no charges are applied to the camera equipped cellular phone 1.

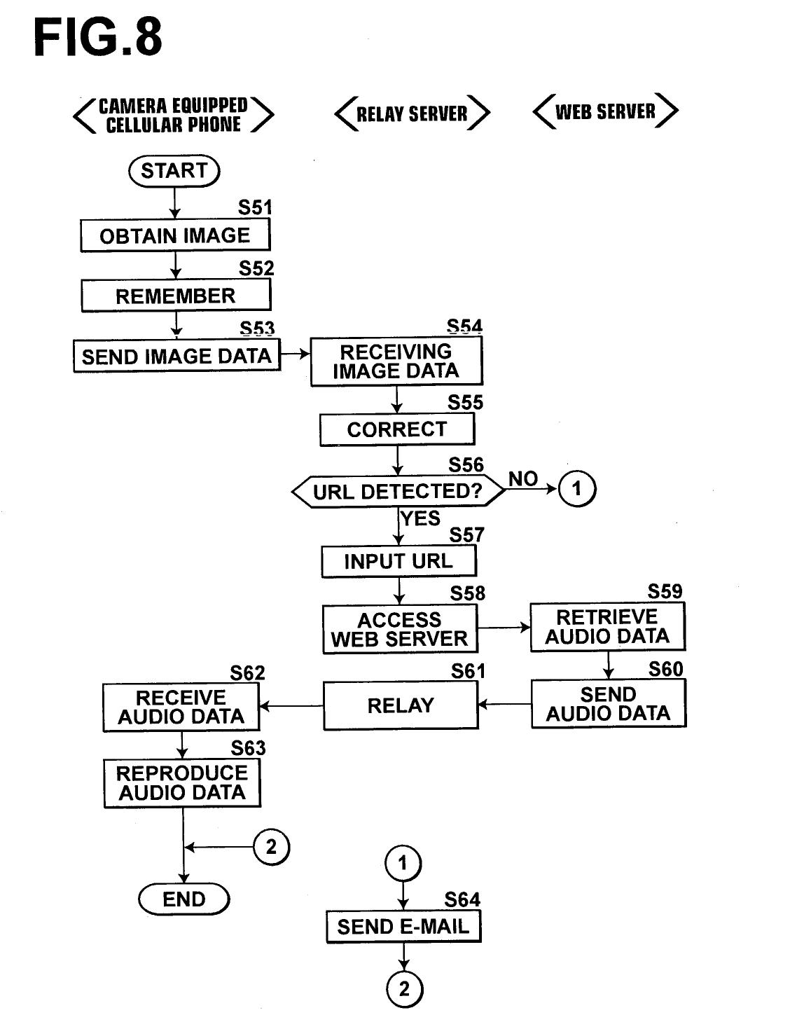

Continuing, the processing carried out according to the fourth embodiment will be explained. FIG. 8 is a flowchart of the operation of the fourth embodiment. Note that the receiving user has been given a print P. First, at the command of the receiving user, the imaging portion 11 images the printed matter P to obtain image data S0 (step S51) The memory portion 15 temporarily stores the image data S0 (step S52). Then, the communication portion 14 reads out the image data S0 from the memory portion 15 and sends the data J0 to the relay server 6 over the public communication circuit 3 (step S53).

The relay system 61 of the relay server 6 receives the image data S0 (step S54), and the distortion correcting portion 62 corrects the geometric distortions included in the image data S0 to obtain corrected image data S1 (step S55). Then, the data detecting portion 63 determines whether or not it is possible to detect the URL of the storage location of the audio data O1 from the corrected image data S1 (step S56).

If the result of the processing of step S56 is positive, the data detecting portion 63 detects the URL from the corrected image data Si, and inputs the detected URL to the relay system 61 (step S57). The relay system 61 accesses, based on said URL, the Web server 7a over a network 8 (step S58).

The Web server 7a detects the audio data O1 (step S59), and sends the detected audio data O1 over the network 8 to the relay system 61 (step S60). The relay system 61 relays the audio data O1 to the camera equipped cellular phone 1 (step S61).

The communication portion 14 of the camera equipped cellular phone 1 receives the audio data O1 (step S62), and the audio output portion 18 reproduces the audio data O1, whereupon the processing is complete.

On the other hand, if the result of the processing of step S56 is negative, the relay portion 61 sends an email describing the fact that the aforementioned URL has not been embedded in the aforementioned print P to the camera equipped cellular phone 1, and the processing is completed.

Note that according to the above described first through fourth embodiments, the URL of the storage location of the audio data O1 has been embedded as a digital watermark, however, the phone number of person who obtained the image data S10 representing the image recorded on the printed matter P can be embedded instead. In this case, the person who has obtained the image data can secretly send their phone number to the user of the camera equipped cellular phone 1 without revealing it to any third party. On the other hand, the user of the camera equipped cellular phone 1 can obtain the phone number of the person who obtained the image data S0 from the image obtained by the imaging of the printed matter P by the camera equipped cellular phone 1, whereby the user of the camera equipped cellular phone 1 can telephone the person who obtained the image recorded on the printed matter P.

Further, according to the above described first through fourth embodiments, the audio data O1 stored in the image server 2 has been sent to the camera equipped cellular phone 1, however, for the case in which the URL is that of a server other than the image server 2, the image server 2 can access said other server to obtain the audio data O1, and send the obtained audio data O1 to the camera equipped cellular phone 1.

What is claimed is:

1. A data detection method comprising the steps of:
receiving input of image data representing an image of printed matter having recorded thereon an image to which data has been attached, which has been obtained by imaging, by use of an imaging means,
correcting the geometrical distortions of the image data to obtain a corrected image data, and
detecting the embedded data from said corrected image data.

2. A data detection method as defined in claim 1, wherein
the data is attached to the image by being concealedly embedded in said image.

3. A data detection method as defined in claim 1, wherein
the imaging means is a camera with which a portable terminal apparatus has been provided.

4. A data detection method as defined in claim 2, wherein
the imaging means is a camera with which a portable terminal apparatus has been provided.

5. A data detection method as defined in claim 1, wherein
the data is a storage location data representing the storage location of audio data that has been associated with the image data, and
the audio data is obtained based on said storage location data.

6. A data detection method as defined in claim 2, wherein
the data is a storage location data representing the storage location of audio data that has been associated with the image data, and
the audio data is obtained based on said storage location data.

7. A data detection method as defined in claim 3, wherein
the data is a storage location data representing the storage location of audio data that has been associated with the image data, and
the audio data is obtained based on said storage location data.

8. A data detection method as defined in claim 4, wherein
the data is a storage location data representing the storage location of audio data that has been associated with the image data, and
the audio data is obtained based on said storage location data.

9. A data detection apparatus, comprising:
an image data inputting means for receiving input of image data representing an image of printed matter having recorded thereon an image to which data has been attached, which has been obtained by imaging, by use of an imaging means,
a correcting means for correcting geometrical distortions of the image data to obtain corrected image data, and
a data detecting means for detecting the embedded data from said corrected image data.

10. A data detection apparatus as defined in claim 9, wherein
the data is attached to the image by being concealedly embedded in said image.

11. A data detection apparatus as defined in claim 9, wherein
the imaging means is a camera with which a portable terminal apparatus has been provided.

12. A data detection apparatus as defined in claim 10, wherein
the imaging means is a camera with which a portable terminal apparatus has been provided.

13. A data detection apparatus as defined in claims 9, wherein
the data is a storage location data representing the storage location of audio data that has been associated with the image, the data detection apparatus further comprising
an audio data obtaining means for obtaining, based on said storage location data, the audio data.

14. A data detection apparatus as defined in claims 10, wherein
the data is a storage location data representing the storage location of audio data that has been associated with the image, the data detection apparatus further comprising
an audio data obtaining means for obtaining, based on said storage location data, the audio data.

15. A data detection apparatus as defined in claims 11, wherein
the data is a storage location data representing the storage location of audio data that has been associated with the image, the data detection apparatus further comprising
an audio data obtaining means for obtaining, based on said storage location data, the audio data.

16. A data detection apparatus as defined in claims 12, wherein
the data is a storage location data representing the storage location of audio data that has been associated with the image, the data detection apparatus further comprising
an audio data obtaining means for obtaining, based on said storage location data, the audio data.

17. A program for causing a computer to execute a data detection method, comprising the procedures of:
a receiving procedure for receiving input of image data representing an image of printed matter having recorded thereon an image to which data has been attached, which has been obtained by imaging, by use of an imaging means,
a corrected image data obtaining procedure for correcting the geometrical distortions of the image data to obtain a corrected image data, and
a detection procedure for detecting the embedded data from said corrected image data.

18. A program as defined in claim 17,-wherein
the data is attached to the image by being concealedly embedded in said image.

19. A program as defined in claim 17, wherein
the imaging means is a camera with which a portable terminal apparatus has been provided.

20. A program as defined in claim 18, wherein
the imaging means is a camera with which a portable terminal apparatus has been provided.

21. A program as defined in claim 17, wherein
the data is a storage location data representing the storage location of audio data that has been associated with the image, further comprising
an audio data obtaining procedure for obtaining, based on said storage location data, the audio data.

22. A program as defined in claim 18, wherein
the data is a storage location data representing the storage location of audio data that has been associated with the image, further comprising
an audio data obtaining procedure for obtaining, based on said storage location data, the audio data.

23. A program as defined in claim 19, wherein
the data is a storage location data representing the storage location of audio data that has been associated with the image, further comprising
an audio data obtaining procedure for obtaining, based on said storage location data, the audio data.

24. A program as defined in claim 20, wherein
the data is a storage location data representing the storage location of audio data that has been associated with the image, further comprising
an audio data obtaining procedure for obtaining, based on said storage location data, the audio data.
